(19) United States
(12) Patent Application Publication
(10) Pub. No.: US 2024/0255445 A1
(43) Pub. Date: Aug. 1, 2024

(54) X-RAY TRANSMISSION INSPECTION APPARATUS AND X-RAY TRANSMISSION INSPECTION METHOD

(71) Applicant: HITACHI HIGH-TECH SCIENCE CORPORATION, Tokyo (JP)

(72) Inventor: Satoshi MATSUBARA, Tokyo (JP)

(21) Appl. No.: 18/409,492

(22) Filed: Jan. 10, 2024

(30) Foreign Application Priority Data
Jan. 31, 2023 (JP) 2023-013467

(51) Int. Cl. G01N 23/18; G01B 15/02; G01N 23/083

(52) U.S. Cl. CPC G01N 23/18; G01B 15/025; G01N 23/083; G01N 2223/652

(57) ABSTRACT

Proposed are an X-ray transmission inspection apparatus and an X-ray transmission inspection method, in which the size (planar area) a foreign object can be obtained with higher precision. The inspection apparatus includes an X-ray source configured to irradiate a sample with an X-rays, an X-ray sensor configured to detect transmitted X-rays, and a calculation part configured to calculate a planar area of a foreign object in the sample, wherein the calculation part obtains luminance distribution divided into a plurality of pixels according to luminance of the transmitted X-rays in a plane perpendicular to an irradiation direction of the X-rays, calculates, as numbers of effective pixels, numbers of the pixels having luminance reduction amounts greater than or equal to a luminance reduction threshold, and calculates the planar area of the foreign object based on the numbers of the effective pixels.

### CROSS REFERENCE TO RELATED APPLICATION

The present application claims priority to Japan Patent Application No. 2023-013467, filed Jan. 31, 2023, the entire contents of which are incorporated herein for all purposes by this reference.

### BACKGROUND OF THE INVENTION

### Field of the Invention

The present disclosure relates to an X-ray transmission inspection apparatus and an X-ray transmission inspection method, in which a metal foreign object in a sample can be detected.

### Description of the Related Art

Recently, a lithium-ion secondary battery, which has a higher energy density than a nickel-metal hydride battery, is a type of non-aqueous electrolyte secondary battery, in which lithium ions in an electrolyte are responsible for electrical conduction and metallic lithium is not included. The lithium-ion secondary battery is used as a battery for vehicles including personal computers and mobile phones, hybrid vehicles, and electric vehicles.

Generally, an X-ray transmission inspection performed by an X-ray transmission image obtained by irradiating a sample with X-rays to detect a metal foreign object in the sample is used. For example, the X-ray transmission inspection is used to inspect a foreign object in a material of the lithium ion secondary battery.

For example, a conventional technology of Patent Document 1 discloses an inspection method and an inspection device for a membrane electrode assembly, in which in a constant cylindrical Fe foreign object sample with a thickness of 20 μm, a correlation between a diameter and a luminance reduction amount is obtained in advance, and it is determined whether a foreign object of a predetermined size or larger is included in the membrane electrode assembly. In FIG. 2 of Patent Document 1, in each of cylindrical Fe foreign object samples with thicknesses of 20 μm and different diameters, the magnitude of the luminance reduction amount is indicated with an arrow, and it is regarded that there is a linear correlation between the size (a planar area) of the foreign object and a portion with the largest luminance reduction amount.

In addition, a conventional technology of Patent Document 2 discloses an inspection method and an inspection apparatus of a membrane electrode assembly, in which the method includes a first process of acquiring an X-ray transmission image of the membrane electrode assembly, a second process of specifying a luminance-reduced region in the X-ray transmission image acquired in the first process, the luminance-reduced region being lower in luminance than a surrounding region, a third process of correcting the luminance of the luminance-reduced region specified in the second process according to the planar size of the luminance-reduced region on the basis of a correlation between a planar size of a foreign object in the membrane electrode assembly and luminance change due to X-ray diffraction, and a fourth process of obtaining the thickness of the foreign object in the membrane electrode assembly on the basis of luminance corrected in the third process.

In the technology of Patent Document 2, the planar size of a luminance-reduced region is calculated by specifying a set of pixels with a luminance value 10 or more times lower than the luminance value of surrounding pixels as the luminance-reduced region (See paragraph 0018).

### Documents of Related Art

(Patent Document 1) Japan Patent Application Publication No. 2021-135125
(Patent Document 2) Japan Patent Application Publication No. 2022-141078

### SUMMARY OF THE INVENTION

The related art described above has the problems described below.

In Patent Document 1 described above, only a correlation between the size of a foreign object and a luminance reduction amount is considered, and a correlation between the thickness of the foreign object and the luminance reduction amount cannot be considered. For example, in case of a disc-shaped foreign object, as illustrated in FIG. 10, a luminance reduction amount is set to change linearly with respect to a change in a diameter of the foreign object. Accordingly, since the size of the foreign object is estimated from the luminance reduction amount by setting the thickness of the foreign object as a fixed value, the thickness of the estimated three-dimensional shape of the foreign object also becomes a fixed value. Accordingly, due to these factors, the technology of Patent Document 1 has a problem in that the estimation precision of the size of a foreign object is low.

In addition, in Patent Document 2, the planar size of a luminance-reduced region is calculated by specifying a set of pixels with a luminance value 10 or more times lower than the luminance value of surrounding pixels as the luminance-reduced region. However, since the luminance values for specifying the luminance-reduced region are fixed values, it is not possible to consider that the luminance-reduced region changes depending on the difference in the thicknesses of the foreign object even if the plane size of the foreign object is the same. Accordingly, due to these factors, the technology of Patent Document 2 has a problem in that the estimation precision of the planar size and three-dimensional size of a foreign matter is low.

Accordingly, in the conventional technology described above, the size (a planar area) of a foreign object from a luminance reduction amount is calculated, but when there is difference between the reference thickness of a foreign object and the actual thickness of the foreign object, there is a problem of underestimating or overestimating the size of the foreign object.

The present disclosure is made in consideration of the above-mentioned problems, and is intended to provide an X-ray transmission inspection apparatus and an X-ray transmission inspection method, in which the size (a planar area) of a foreign object can be obtained with higher precision.

The present disclosure employs the following configurations to solve the above problems. That is, an X-ray transmission inspection apparatus according to a first invention includes: an X-ray source configured to irradiate a sample with X-rays; an X-ray sensor installed on a side opposite to the X-ray source with respect to the sample and configured to detect transmitted X-rays when the X-rays pass through the sample; and a calculation part configured to calculate a planar area of a foreign object in the sample based on the transmitted X-rays detected by the X-ray sensor, wherein the calculation part obtains luminance distribution divided into a plurality of pixels according to luminance of the transmitted X-rays in a plane perpendicular to an irradiation direction of the X-rays, calculates, as numbers of effective pixels, numbers of the pixels having luminance reduction amounts greater than or equal to a luminance reduction threshold that is in a predetermined ratio to a maximum luminance reduction amount which is the largest luminance reduction amount in the luminance distribution, and calculates the planar area of the foreign object based on the numbers of effective pixels.

In the X-ray transmission inspection apparatus, the calculation part obtains luminance distribution divided into a plurality of pixels according to the luminance of transmitted X-rays in a plane perpendicular to the irradiation direction of each of X-rays, calculates, as the numbers of effective pixels, the numbers of pixels having luminance reduction amounts greater than or equal to a luminance reduction threshold that is in a predetermined ratio to the maximum luminance reduction amount which is the largest luminance reduction amount in the luminance distribution, and calculates the planar area of the foreign object on the basis of the numbers of effective pixels, so the size (planar area) of the foreign object may be obtained with high precision.

That is, in a conventional technology, a thickness of a foreign object is not sufficiently considered, and thus when a pre-estimated thickness of a foreign object is different from an actual thickness thereof, the size (planar area) of the foreign object cannot be obtained with precision. However, in the present disclosure, the planar area of the foreign object is obtained from the numbers of effective pixels having luminance reduction amounts greater than or equal to the luminance reduction threshold that is in a predetermined ratio to the maximum luminance reduction amount, and accordingly, even if the thickness of the foreign object changes, the numbers of effective pixels may not change, so the planar area of the foreign object may be obtained with high precision without depending on the thickness of the foreign object.

The X-ray transmission inspection apparatus according to a second invention features that in the first invention, the calculation part may calculate the planar area based on the a plurality of the numbers of effective pixels calculated with a plurality of the luminance reduction thresholds that are different from one another.

That is, in the X-ray transmission inspection apparatus, the calculation part may calculate the planar area based on the plurality of the numbers of the effective pixels calculated with the plurality of the different luminance reduction thresholds, so the planar area of the foreign object may be obtained with higher precision.

The X-ray transmission inspection apparatus according to the first or second invention features that the calculation part may calculate thickness of the foreign object based on a relationship between the maximum luminance reduction amount and a thickness of the foreign object obtained in advance.

That is, in the X-ray transmission inspection apparatus, the calculation part may calculate the thickness of the foreign object based on the relationship between the maximum luminance reduction amount and the thickness of the foreign object obtained in advance, so volume of the foreign object may be obtained from the calculated planar area and thickness of the foreign object.

The X-ray transmission inspection apparatus according to a fourth invention features that in the third invention, the calculation part may calculate a volume of the foreign object from the obtained planar area and thickness of the foreign object.

That is, in the X-ray transmission inspection apparatus, the calculation part may calculate the volume of the foreign object from the obtained planar area and thickness of the foreign object, so the three-dimensional size of the foreign object may be obtained.

An X-ray transmission inspection method according to a fifth invention includes: irradiating a sample with X-rays from the X-ray source; detecting transmitted X-rays when the X-rays pass through the sample by using the X-ray sensor installed on a side opposite to the X-ray source with respect to the sample; and calculating a planar area of a foreign object in the sample based on the transmitted X-rays detected by the X-ray sensor, wherein the calculating a planar area of a foreign object in the sample based on the transmitted X-rays detected by the X-ray sensor includes: obtaining luminance distribution divided into a plurality of pixels according to luminance of the transmitted X-rays in a plane perpendicular to an irradiation direction of the X-rays; calculating, as numbers of effective pixels, numbers of the pixels having luminance reduction amounts greater than or equal to a luminance reduction threshold that is in a predetermined ratio to a maximum luminance reduction amount which is the largest luminance reduction amount in the luminance distribution; and calculating the planar area of the foreign object based on the numbers of effective pixels.

The X-ray transmission inspection method according to a sixth invention features that in the fifth invention, the calculating of the numbers of the pixels having luminance reduction amounts greater than or equal to a luminance reduction threshold that is in a predetermined ratio to a maximum luminance reduction amount may calculates a plurality of the numbers of effective pixels with a plurality of the luminance reduction thresholds that are different from one another, and the step of calculating of the planar area may calculate the planar area based on the plurality of the numbers of effective pixels that are caculated.

The X-ray transmission inspection method according to a seventh invention features that in the fifth or sixth invention, the step of calculating the planar area may include calculating thickness of the foreign object based on a relationship between the maximum luminance reduction amount and thickness of the foreign object obtained in advance.

The X-ray transmission inspection method according to an eighth invention features that in the seventh invention, the step of calculating the planar area may include calculating a volume of the foreign object from the planar area that is obtained and thickness of the foreign object.

According to the present disclosure, the following effects are obtained.

That is, according to the X-ray transmission inspection apparatus and the X-ray transmission inspection method according to the present disclosure, luminance distribution divided into a plurality of pixels according to the luminance of transmitted X-rays in a plane perpendicular to the irradiation direction of each of X-rays is obtained, the numbers of pixels having luminance reduction amounts greater than or equal to a luminance reduction threshold that is in a predetermined ratio to the maximum luminance reduction amount which is the largest luminance reduction amount in the luminance distribution are calculated as the numbers of effective pixels, and the planar area of the foreign object is calculated on the basis of the numbers of effective pixels, thereby enabling the size (planar area) of the foreign object to be obtained with high precision.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a schematic overall configuration view illustrating an X-ray transmission inspection apparatus in an embodiment of the X-ray transmission inspection apparatus and X-ray transmission inspection method of the present disclosure;

FIG. 2 is a view illustrating an example of a foreign object transmission image of X-rays passing through a foreign object in this embodiment;

FIG. 3 is a flowchart illustrating the X-ray transmission inspection method in this embodiment:

FIGS. 4A and 4B respectively are a graph illustrating the amount of luminance reduction for a thick foreign object and graph illustrating the amount of luminance reduction for a thin foreign object in this embodiment:

FIG. 5 is a graph illustrating a relationship between a diameter of a foreign object and the number of pixels thereof in this embodiment:

FIG. 6 is a graph illustrating a relationship between the thickness of a foreign object and the amount of luminance reduction thereof in this embodiment:

FIGS. 7A and 7B are explanatory diagrams for calculating the numbers of effective pixels with a plurality of luminance reduction thresholds in this embodiment:

FIG. 8 is a diagram illustrating a case in which the number of pixels having luminance reduction amounts greater than or equal to a plurality of different luminance reduction thresholds R11 is counted with a plurality of luminance reduction thresholds in this embodiment:

FIG. 9 is a linear graph illustrating a correlation between luminance reduction thresholds and the numbers of effective pixels in this embodiment; and

FIG. 10 is a graph illustrating a relationship between a diameter of a foreign object and a luminance reduction amount in the conventional technology of the X-ray transmission inspection apparatus and the X-ray transmission inspection method according to the present disclosure.

### DETAILED DESCRIPTION OF THE INVENTION

Hereinafter, an embodiment of the X-ray transmission inspection apparatus and X-ray transmission inspection method according to the present disclosure will be described with reference to FIGS. 1, 2, 3, 4A, 4B, 5, 6, 7A, 7B, 8, and 9.

As illustrated in FIG. 1, the X-ray transmission inspection apparatus 1 according to this embodiment includes an X-ray source 2 configured to irradiate a sample S with an X-rays X1, an X-ray sensor 3 installed on a side opposite to the X-ray source 2 with respect to the sample S and configured to detect transmitted X-rays when the X-rays X1 pass through the sample S, and a calculation part 4 configured to calculate a planar area of a foreign object A in the sample S on the basis of the transmitted X-rays detected by the X-ray sensor 3.

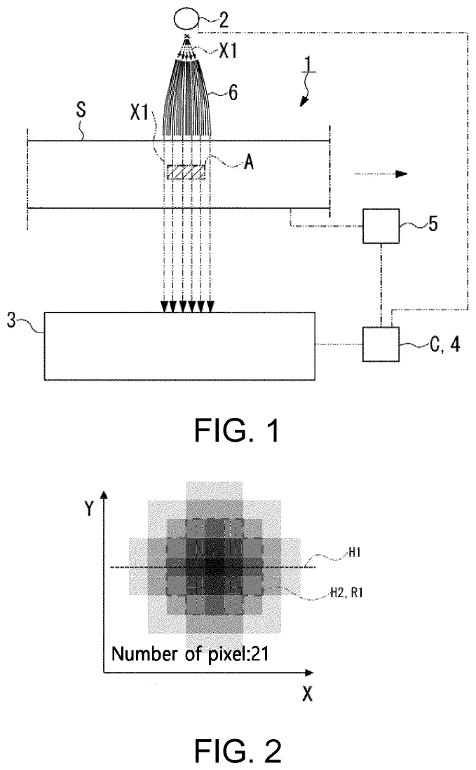

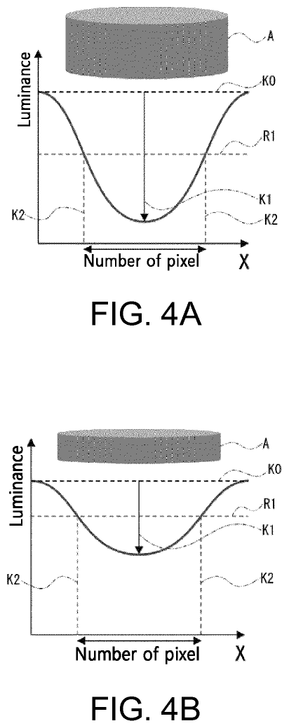

The calculation part 4 obtains luminance distribution divided into a plurality of pixels according to the luminance of transmitted X-rays in a plane perpendicular to the irradiation direction of an X-rays X1 as illustrated in FIG. 2, and as illustrated in FIGS. 2, 4A, and 4B, calculates, as the numbers of effective pixels, the numbers of pixels having luminance reduction amounts greater than or equal to a luminance reduction threshold R1 that is in a predetermined ratio to a maximum luminance reduction amount K1 which is the largest luminance reduction amount in the luminance distribution, and calculates the planar area of the foreign object A based on the number of effective pixels.

The planar area of the foreign object A is an area of the foreign object A seen from the irradiation side of the X-rays X1. In addition, in this embodiment, the planar area the foreign object A is also referred to as the size of the foreign object.

In addition, the luminance reduction amount refers to the amount of luminance reduction from the maximum luminance of an X-ray transmission image (a transmitted X-ray), and represents the attenuation amount of the X-rays X1.

The calculation part 4 also has a function of calculating the planar area of a foreign object on the basis of the numbers of a plurality of effective pixels calculated with a plurality of different luminance reduction thresholds. For example, the calculation part 4 has a function of calculating a planar area of a foreign object by using the average value of the numbers of a plurality of effective pixels calculated with a plurality of different luminance reduction thresholds as the number of effective pixels.

In addition, the calculation part 4 has a function of calculating the thickness of a foreign object A on the basis of a relationship between the maximum luminance reduction amount and the thickness of the foreign object A obtained in advance.

In addition, the X-ray transmission inspection apparatus 1 according to this embodiment includes a sample moving mechanism 5 configured to move the sample S in the transport direction (a direction orthogonal to the depth direction of the sample S) during irradiation with an X-rays X1 from the X-ray source 2, and a control device C configured to control the X-ray source 2, the X-ray sensor 3, the sample moving mechanism 5 and the calculation part 4.

In addition, the control device C includes the calculation part 4.

For example, the sample S is a strip-shaped material for lithium-ion batteries or a material used in the pharmaceutical industry.

The X-ray source 2, which is an X-ray tube capable of performing irradiation with an X-rays X1, emits, from a window of beryllium foil, an X-rays X1 generated when hot electrons generated from a filament (cathode) in the tube are accelerated by a voltage applied between the filament (cathode) and a target (anode) and collide with tungsten (W), molybdenum (Mo), and chromium (Cr) of the target.

In addition, the X-ray transmission inspection apparatus 1 according to this embodiment includes a polycapillary 6 which converts X-rays X1 from the X-ray source 2 into parallel X-rays. In addition, the X-ray transmission inspection apparatus 1 according to this embodiment may include a collimator which limits the spread of X-rays X1 from the X-ray source 2.

The X-ray sensor 3 is a line sensor, such as a time delay integration (TDI) sensor, extending in a perpendicular direction (an inspection width direction) with respect to the transport directions in which a sample S moves.

A TDI sensor has a plurality of cells (sensor elements) disposed on a surface facing a corresponding X-ray source, and is provided with a fluorescent body disposed on a detection surface, a fiber optic plate (FOP) in which a plurality of optical fibers are arranged in multiple rows vertically and horizontally in a two-dimensional manner under the fluorescent body, and a Si light-receiving element disposed under the FOP. The TDI sensor has the configuration of line sensors arranged in multiple rows.

For example, in the X-ray sensor 3, the TDI sensor is configured by 200 to 1000 unit line sensors lined up in the transport direction of the sample S.

The control device C is a computer including a CPU which is connected to and controls the X-ray source 2, the X-ray sensor 3, and the sample moving mechanism 5.

The control device C adjusts the direction and speed of charge transfer of the X-ray sensor 3, which is the TDI sensor, to the moving direction and speed of the sample S, and has the function of integrating the luminance values of X-rays received by the X-ray sensor 3 in the detection area of a light-receiving surface.

The sample moving mechanism 5 is, for example, a motor that can move relative to the X-ray sensor 3 in a direction in which a sheet-shaped sample S extends. For example, the sample moving mechanism 5 includes at least one pair of rollers configured to move a strip-shaped sample S in an extension direction thereof in a roll-to-roll manner.

The calculation part 4 has a function of obtaining a contrast image (luminance distribution) from an X-ray transmission image representing the distribution of the intensity of detected transmitted X-rays.

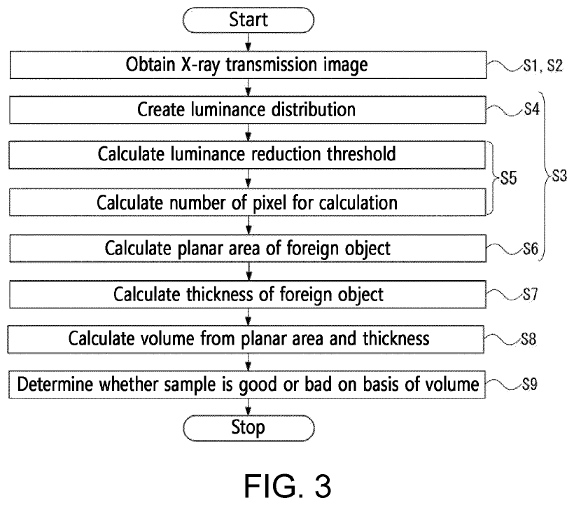

As illustrated in FIG. 3, the X-ray transmission inspection method using the X-ray transmission inspection apparatus 1 of this embodiment includes irradiating the sample S with X-rays X1 from the X-ray source 2 at S1, detecting transmitted X-rays by using the X-ray sensor 3 installed on a side opposite to the X-ray source 2 with respect to the sample S when the X-rays X1 pass through the sample S at S2, and calculating a planar area of the foreign object A in the sample S on the basis of the transmitted X-rays detected by the X-ray sensor 3 at S3.

The calculating at S3 includes obtaining luminance distribution divided into a plurality of pixels according to the luminance of transmitted X-rays in the plane perpendicular to the irradiation direction of the X-rays X1 at S4, calculating, as the numbers of effective pixels, the numbers of pixels having luminance reduction amounts greater than or equal to the luminance reduction thresholds R1 that is in a predetermined ratio to the maximum luminance reduction amount K1 which is the largest luminance reduction amount in the luminance distribution at S5, and calculating the planar area of the foreign object A on the basis of the numbers of effective pixels at S6.

In addition, in the calculating of the number of pixels at S5, the numbers of a plurality of effective pixels are calculated with a plurality of different luminance reduction thresholds R1, and in the calculating of the planar area at S6, the planar area may be calculated by using the average of the numbers of a plurality of effective pixels as the number of effective pixels.

In addition, the calculating at S3 includes calculating the thickness of the foreign object A on the basis of a relationship between the maximum luminance reduction amount and the thickness of the foreign object A obtained in advance at S7.

In addition, the calculating at S3 includes calculating the volume of the foreign object from the obtained planar area and thickness of the foreign object A at S8.

The calculating S3 of the X-ray transmission inspection method will be described in more detail with reference to FIGS. 2, 3, 4A, 4B, 5, 6, 7A, and 7B.

As described above, in the calculating at S3, from the detected X-ray transmission image of the foreign object A, the calculation part 4 obtains a luminance reduction amount and the number of pixels greater than or equal to a luminance reduction threshold, and calculates the size (planar area) and thickness of the foreign object A from these values. In addition, the calculation part 4 additionally calculates the volume of the foreign object A from the size and thickness of the foreign object A, and determines whether a foreign object A of a specified size or more is included by comparing the size and thickness of the foreign object A with the threshold of the volume,

That is, in the obtaining of luminance distribution at S4, as illustrated in FIG. 2, the calculation part 4 obtains the luminance distribution divided into a plurality of pixels according to the luminance of transmitted X-rays detected by the X-ray sensor 3 in the plane (an X-Y plane) perpendicular to the irradiation direction of the X-rays X1 and specifies a luminance-reduced region. In the luminance distribution of FIG. 2, as the amount of luminance reduction increases, the darkness of pixels is illustrated to increase.

In addition, in a graph in which change in the luminance of a dotted line H1 passing through a portion which is the largest luminance reduction amount in the luminance distribution of FIG. 2, that is, change in luminance in an X direction as illustrated in FIG. 4A is illustrated, the length of an arrow extending vertically between the dotted line K0 (maximum luminance) of FIG. 4A and a portion having lowest luminance corresponds to the maximum luminance reduction amount K1.

The luminance reduction threshold R1 is set by multiplying the maximum luminance reduction amount K1 by a predetermined ratio for each foreign object. For example, as illustrated in FIGS. 4A and 4B, the predetermined ratio is 50%, and 50% of the maximum luminance reduction amount K1 is set as the luminance reduction threshold R1. In addition, as illustrated in FIG. 4A, when the foreign object A is thick, the number of transmitted X-rays is relatively small, so the maximum luminance reduction amount K1 is great, However, as illustrated in FIG. 4B, when the foreign object A is thin, the number of transmitted X-rays is large, so the maximum luminance reduction amount K1 is small.

On the basis of the luminance reduction threshold R1 obtained in this way, in the calculating of the number of pixels at S5, as illustrated in each of FIGS. 4A and 4B, in a luminance curve, the number of pixels corresponding to a part between a pair of dotted lines K2 extending in a luminance axial direction perpendicularly from the portion of the luminance reduction threshold R1 is calculated as the number of effective pixels. That is, as illustrated in FIG. 2, pixels surrounded by a dotted line H2 are pixels having luminance reduction amounts greater than or equal to the luminance reduction threshold R1 and are calculated as the number of effective pixels (the number of pixels in FIG. 2 is 21).

In addition, in the technology of Patent Document 2, in calculating the number of pixels for obtaining the planar size of the luminance-reduced region, a luminance value 10 or more times lower than the luminance value of surrounding pixels is fixedly used. However, in this embodiment, a luminance reduction amount (a luminance reduction threshold) obtained by multiplying the maximum value of a luminance reduction amount by a predetermined ratio for each foreign object is used.

In addition, the technology of Patent Document 2 and the technology of this embodiment are different from one another in that in the technology of Patent Document 2, the threshold of one luminance value based on the luminance value of surrounding pixels regardless of a foreign object is used fixedly, but in this embodiment, the luminance reduction threshold R1 based on the maximum value of a luminance reduction amount (the maximum luminance reduction amount K1) for each foreign object A is used.

Next, the calculating of the planar area at S6, the luminance reduction threshold R1 is set as a ratio to a luminance reduction amount for each foreign object A, so it is possible to calculate the planar area of the foreign object A regardless of the thickness of a foreign object.

This is because the luminance reduction amount of a pixel is proportional to the ratio of X-rays that pass through a foreign object A.

That is, this embodiment utilizes the fact that the ratio of a luminance reduction amount to a portion with a largest luminance reduction amount is not related to the thickness of a foreign object, but is related to the size (planar area) of the foreign object.

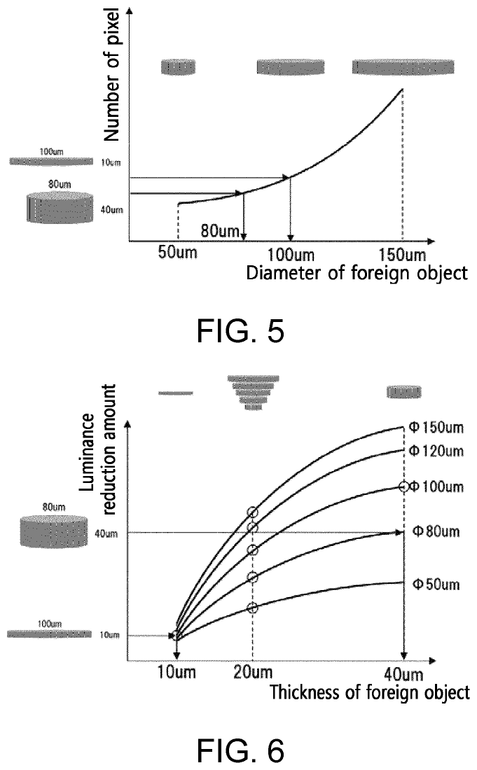

For example, as illustrated in FIG. 5, a relationship between the planar area (diameter) of a foreign object and the numbers of pixels (the numbers of effective pixels) having luminance reduction amounts greater than or equal to a luminance reduction threshold is obtained by using a known standard foreign object. The relationship is stored in the calculation part 4, and the calculation part 4 obtains the planar area (diameter) of the foreign object A corresponding to each of the calculated numbers of effective pixels on the basis of the relationship.

In the graph illustrated in FIG. 5, in order to obtain the above relationship, a disc-shaped foreign object as a known standard foreign object is employed, and a diameter as a value directly corresponding to the planar area of the foreign object is represented at a horizontal axis.

In addition, the relationship between the planar area (diameter) of a foreign object and the number of pixels (the number of effective pixels) greater than or equal to a luminance reduction threshold is not obtained by using a known standard foreign object, but on the basis of the luminance distribution of FIG. 2, an area of a foreign object corresponding to the numbers of pixels (the numbers of effective pixels) greater than or equal to the luminance reduction threshold may be obtained so that the planar area (size) of the foreign object A is calculated. In this case, it is possible to obtain the planar area of a foreign object A having a planar shape other than a circle.

Next, in the calculating of the thickness at S7, as illustrated in FIG. 6, by using a standard foreign object with known thickness and diameter, a relationship between the thickness and maximum luminance reduction amount of the foreign object is obtained, and the calculation part 4 calculates the thickness of the foreign object A on the basis of the thickness and maximum luminance reduction amount of the foreign object.

In addition, the ratio of the maximum luminance reduction amount of foreign objects different in diameter does not depend on the thickness of the foreign objects. That is, when the maximum luminance reduction amount of a foreign object which serves as a reference to some extent is obtained, the maximum luminance reduction amount of a foreign object of a diameter which has not been obtained can be obtained by calculation. In other words, the maximum luminance reduction amount is the product of a function of the diameter of a foreign object and a function of the thickness of the foreign object.

In addition, by setting a plurality of luminance reduction thresholds, the estimation precision of the size of a foreign object is improved. That is, as described above, in the calculating of the number of pixels at S5, the numbers of a plurality of effective pixels are calculated with a plurality of different luminance reduction thresholds, and in the calculating of a planar area at S6, the planar area of a foreign object is calculated by using the average of the numbers of a plurality of effective pixels as the number of effective pixels.

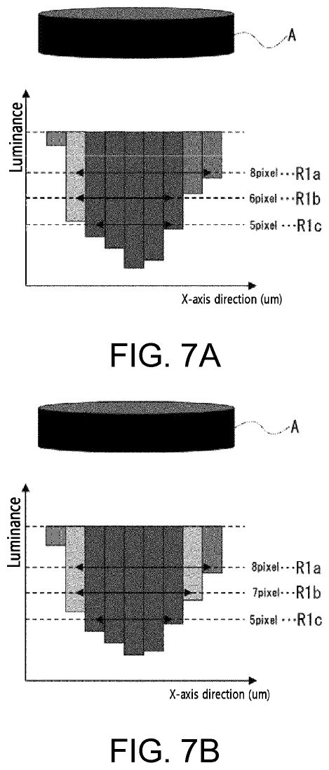

For example, FIGS. 7A and 7B illustrate the numbers of pixels of a case in which for a foreign object A, the numbers of effective pixels having luminance reduction amounts greater than or equal to luminance reduction thresholds are counted with a plurality of luminance reduction thresholds.

In FIG. 7A, in the first measurement of a foreign object A, when luminance reduction thresholds R1a, R1b, and R1c are used for counting in three stages, the numbers of effective pixels of the luminance reduction thresholds R1a, R1b, and R1c are 8, 6, and 5, respectively, and the average of the numbers of effective pixels is 6.3.

In addition, in FIG. 7B, in the second measurement of a foreign object A, when the luminance reduction thresholds R1a, R1b, and R1c are used for counting in three stages, the numbers of effective pixels of the luminance reduction thresholds are 8, 7, and 5, respectively, and the average of the numbers of effective pixels is 6.6.

Accordingly, even in the same foreign object A, non-uniformity in luminance distribution occurs due to non-uniformity of measurement. Due to this, for example, when only a luminance reduction threshold Rib is used for calculating, the number of effective pixels of the luminance reduction threshold in the measurement illustrated in FIG. 7A is 6, and the number of effective pixels of the luminance reduction threshold in the measurement illustrated in FIG. 7B is 7, so difference between the numbers of effective pixels is 1. Accordingly, by calculating the average of the result values of a plurality of luminance reduction thresholds, difference between the numbers of effective pixels may be decreased. That is, a value obtained by averaging the numbers of effective pixels by a plurality of luminance reduction thresholds is stable.

In addition, in the calculating of the volume at S8, from the calculated diameter of a foreign object and the calculated thickness of the foreign object, the volume (three-dimensional size) of the foreign object is calculated.

Next, the calculation part 4 determines whether the sample S is good or bad on the basis of the obtained volume (three-dimensional size) of the foreign object at S9.

Accordingly, in the X-ray transmission inspection apparatus 1 and X-ray transmission inspection method of this embodiment, luminance distribution divided into a plurality of pixels according to the luminance of transmitted X-rays in the plane perpendicular to the irradiation direction of the X-rays X1 is obtained, the number of pixels having luminance reduction amounts greater than or equal to the luminance reduction threshold R1 which is a predetermined ratio to the maximum luminance reduction amount K1 which is the largest luminance reduction amount in the luminance distribution is calculated as the number of effective pixels, and the planar area of the foreign object A is calculated based on the number of effective pixels, so it is possible to obtain the size (planar area) of the foreign object A with high precision.

That is, in the conventional technology, the thickness of the foreign object is not sufficiently considered, and thus when the pre-estimated thickness of the foreign object is different from the actual thickness of the foreign object, the size (planar area) of the foreign object cannot be obtained accurately. However, in this embodiment of the present disclosure, the planar area of the foreign object A is obtained from the number of effective pixels having luminance reduction amounts greater than or equal to the luminance reduction threshold R1 which is a predetermined ratio to the maximum luminance reduction amount K1, and accordingly, even if the thickness of the foreign object A changes, the number of effective pixels does not change, so the planar area of the foreign object A can be obtained with high precision without depending on the thickness of the foreign object A.

In addition, by using the average of the numbers of a plurality of effective pixels calculated with the plurality of different luminance reduction thresholds R1 as the number of effective pixels, the planar area is calculated, so it is possible to obtain the planar area of the foreign object A with higher precision.

In addition, on the basis of the maximum luminance reduction amount K1 and the thickness of the foreign object obtained in advance, the thickness of the foreign object A is calculated, so the volume of the foreign object A can be obtained from the calculated planar area and thickness of the foreign object A.

In addition, in the calculating of the planar area by the calculation part 4 at S6, the planar area is calculated by using the average of the numbers of a plurality of effective pixels as the number of effective pixels, and a linear graph representing a correlation between the luminance reduction thresholds and the numbers of effective pixels is created, and from the linear graph of the correlation, the number of effective pixels used to calculate the planar area may be determined.

That is, based on the number of a plurality of effective pixels calculated with a plurality of different luminance reduction thresholds, a correlation between luminance reduction thresholds and the numbers of effective pixels is obtained, and the planar area of a foreign object may be calculated by the number of effective pixels obtained from this correlation.

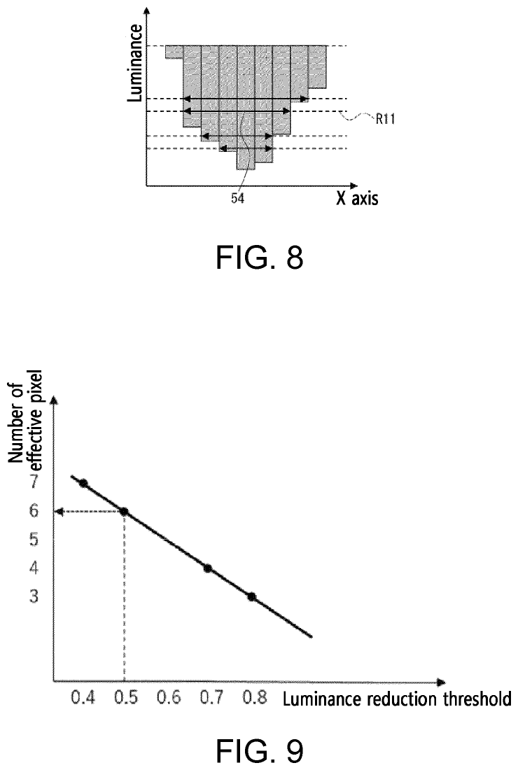

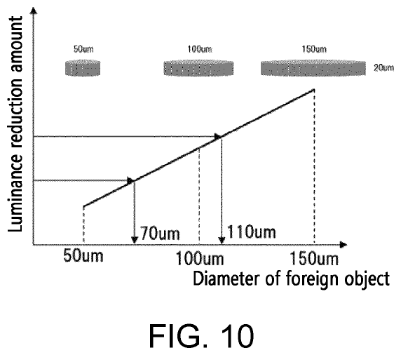

For example, FIG. 8 illustrates the number 54 of effective pixels obtained by counting the number of pixels having luminance reduction amounts greater than or equal to a plurality of different luminance reduction thresholds R11 by a plurality of luminance reduction thresholds. When luminance reduction thresholds R11 are used for counting in four stages, the numbers of effective pixels of the luminance reduction thresholds are 7, 6, 4, and 3, respectively.

As illustrated in FIG. 9, a linear graph illustrating a correlation between luminance reduction thresholds and the numbers of effective pixels is created, and on the basis of the linear graph, the number of effective pixels used to calculate the planar area of a foreign object is determined. In the graph of FIG. 9, when a luminance reduction threshold is 0.5, the number of effective pixels is 6, and this value is used to calculate the planar area.

In the method of calculating a planar area by using the average of the numbers of a plurality of effective pixels as the number of effective pixels, the number of the effective pixels of target luminance reduction thresholds may not be obtained according to a plurality of luminance reduction thresholds, but in the method of determining the number of effective pixels used to calculate a planar area on the basis of a linear graph representing a correlation between luminance reduction thresholds and the numbers of effective pixels, the number of the effective pixels of the target luminance reduction thresholds are necessarily obtained, so it is possible to calculate the planar area with higher precision.

In addition, the technical scope of the present disclosure is not limited to the above-described embodiment, and various changes may be made without departing from the spirit of the present disclosure.

What is claimed is:

1. An X-ray transmission inspection apparatus comprising:
an X-ray source configured to irradiate a sample with X-rays;
an X-ray sensor installed on a side opposite to the X-ray source with respect to the sample and configured to detect transmitted X-rays when the X-rays pass through the sample; and
a calculation part configured to calculate a planar area of a foreign object in the sample based on the transmitted X-rays detected by the X-ray sensor,
wherein the calculation part obtains luminance distribution divided into a plurality of pixels according to luminance of the transmitted X-rays in a plane perpendicular to an irradiation direction of the X-rays, calculates, as numbers of effective pixels, numbers of the pixels having luminance reduction amounts greater than or equal to a luminance reduction threshold that is in a predetermined ratio to a maximum luminance reduction amount, which is the largest luminance reduction amount in the luminance distribution, and calculates the planar area of the foreign object based on the numbers of effective pixels.

2. The X-ray transmission inspection apparatus according to claim 1, wherein the calculation part calculates the planar area based on a plurality of the numbers of effective pixels calculated with a plurality of the luminance reduction thresholds that are different from one another.

3. The X-ray transmission inspection apparatus according to claim 1, wherein, the calculation part calculates thickness of the foreign object based on a relationship between the maximum luminance reduction amount and thickness of the foreign object obtained in advance.

4. The X-ray transmission inspection apparatus according to claim 2, wherein, the calculation part calculates thickness of the foreign object based on a relationship between the maximum luminance reduction amount and thickness of the foreign object obtained in advance.

5. The X-ray transmission inspection apparatus according to claim 3, wherein the calculation part calculates a volume of the foreign object from the obtained planar area and thickness of the foreign object.

6. The X-ray transmission inspection apparatus according to claim 4, wherein the calculation part calculates a volume of the foreign object from the obtained planar area and thickness of the foreign object.

7. An X-ray transmission inspection method comprising:
irradiating a sample with X-rays from an X-ray source;
detecting transmitted X-rays when the X-rays pass through the sample by using an X-ray sensor installed on a side opposite to the X-ray source with respect to the sample; and
calculating a planar area of a foreign object in the sample based on the transmitted X-rays detected by the X-ray sensor,
wherein the step of calculating a planar area of a foreign object in the sample based on the transmitted X-rays detected by the X-ray sensor comprises:
obtaining luminance distribution divided into a plurality of pixels according to luminance of the transmitted X-rays in a plane perpendicular to an irradiation direction of the X-rays;
calculating, as numbers of effective pixels, numbers of the pixels having luminance reduction amounts greater than or equal to a luminance reduction threshold that is in a predetermined ratio to a maximum luminance reduction amount, which is the largest luminance reduction amount in the luminance distribution; and
calculating the planar area of the foreign object based on the numbers of effective pixels.

8. The X-ray transmission inspection method according to claim 7, wherein the step of calculating the numbers of the pixels having luminance reduction amounts greater than or equal to a luminance reduction threshold that is in a predetermined ratio to a maximum luminance reduction amount calculates a plurality of the numbers of effective pixels with a plurality of the luminance reduction thresholds that are different from one another, and
the step of calculating the planar area calculates the planar area based on the plurality of the numbers of effective pixels that are calculated.

9. The X-ray transmission inspection method according to claim 7, wherein the step of calculating the planar area comprises calculating thickness of the foreign object based on a relationship between the maximum luminance reduction amount and thickness of the foreign object obtained in advance.

10. The X-ray transmission inspection method according to claim 8, wherein the step of calculating the planar area comprises calculating thickness of the foreign object based on a relationship between the maximum luminance reduction amount and thickness of the foreign object obtained in advance.

8. The X-ray transmission inspection method according to claim 7, wherein the step of calculating the planar area comprises calculating a volume of the foreign object from the planar area that is obtained and thickness of the foreign object.
